(19) United States
(12) Patent Application Publication
(10) Pub. No.: US 2012/0257009 A1
(43) Pub. Date: Oct. 11, 2012

(54) Image Processing Device and Method for Matching Images Obtained from a Plurality of Wide-Angle Cameras

(75) Inventors: Jun-seok Lee, Gyeongsangbuk-do (KR); Sang-seok Hong, Gyeongsangnam-do (KR); Byung-Chan Jeon, Gyeongsangbuk-do (KR)

(73) Assignee: ETU SYSTEM, LTD., Gyeongsangbuk-do (KR)

(21) Appl. No.: 13/515,805

(22) PCT Filed: Dec. 16, 2009
(86) PCT No.: PCT/KR2009/007547

§ 371 Date: Jun. 13, 2012

(30) Foreign Application Priority Data
Dec. 14, 2009 (KR) 10-2009-0124039

(51) Int. Cl. H04N 7/00

(52) U.S. Cl. 348/36; 348/E07.001

(57) ABSTRACT

The present invention relates to an image processing device and method for matching images obtained from a plurality of wide-angle cameras. There is provided an image processing device for matching images obtained from a plurality of wide-angle cameras, comprising: at least 2 wide-angle cameras arranged in such a way as to overlap with a portion of the photographing area between neighboring cameras; an image signal receiver which receives at least 2 input image signals obtained from the plurality of wide-angle cameras; a lookup table which stores image mapping data concerning the relationship between the respective image pixels that constitute a plurality of input image signals obtained from the plurality of wide-angle cameras and the image pixels of composite image signals; an image matching unit which receives a plurality of input image signals from the image signal receiver and constructs image pixels of composite image signals for the respective image pixels forming each input image signal in reference to the lookup table; and an image signal output unit which creates output images based on the composite image signal configured in the image matching unit. There is also provided an image processing method using this image processing device. The inventive image processing device and method make it possible to configure a plurality of images obtained from a plurality of wide-angle cameras as a single planar image in a swift and efficient manner.

### TECHNICAL FIELD

The present invention relates, in general, to an image processing apparatus and method and, more particularly, to an image processing apparatus and method which can promptly and efficiently process images using a simple method when multiple images obtained from multiple wide-angle cameras are constructed into a single homographic image.

### BACKGROUND ART

Recently, with the development of Information Technology (IT), attempts to graft this IT technology onto vehicles have increased. For example, a black-box device is used in which a camera is mounted on a vehicle to record driving states or the surrounding situation, or a parking assist system is used in which a camera is installed on the rear of a vehicle to capture rear images and to output the captured images on a display device installed inside the vehicle when the vehicle is in reverse. It is reported that this tendency is on a steady uptrend. Meanwhile, of these technologies, a system has been proposed in which wide-angle cameras are installed on the front and rear sides and the left and right sides of a vehicle and images obtained from these cameras are reconstructed into images that appear as if captured by looking down upon the vehicle from just above, that is, in the direction from above, and in which the reconstructed images are displayed on the display device of the vehicle, thus promoting the comfort of a driver. This system is referred to as a bird's-eye view system because it provides images which appear as if a bird's eye were looking down from the sky, or referred to as an Around View Monitoring (AVM) system or the like. This technology employs wide-angle cameras, each equipped with a fish-eye lens, so as to secure a wider viewing angle. When such a wide-angle camera is used, a distorted image is obtained as an initial image signal, so that a procedure for correcting such a distorted image to obtain an undistorted image is required. Further, such a system requires a procedure (that is, homography) for transforming images, captured in a direction horizontal to a ground surface using a plurality of wide-angle cameras installed on the front, rear, left and right sides of the vehicle, into images perpendicular to the ground surface, so that a complicated operation procedure for performing such conversion is required. Furthermore, such a system also requires a single image formation procedure for rearranging a plurality of homographic images into a single image and processing overlapping regions in the rearranged image. Therefore, the conventional bird's-eye view system is problematic in that the computation process is very complicated and procedures of several steps must be processed continuously and in real time, thus greatly increasing the computational load and requiring high-grade specifications and expensive hardware equipment.

### SUMMARY

### Technical Problem

Accordingly, the present invention has been made keeping in mind the above problems occurring in the prior art, and an object of the present invention is to provide an image processing apparatus and method, which can promptly and efficiently construct multiple images obtained from multiple wide-angle cameras into a single homographic image.

Another object of the present invention is to provide an image processing apparatus and method wherein an image processing apparatus for constructing a plurality of multi-channel input images into a single homographic image can be manufactured at low cost, and real-time processing can be guaranteed even with lower-grade specifications.

### Technical Solution

In accordance with an aspect of the present invention to accomplish the above objects, there is provided an image processing apparatus for matching images obtained from multiple wide-angle cameras, including two or more multiple wide-angle cameras arranged such that capturing regions between neighboring cameras partially overlap each other; an image signal reception unit for receiving two or more multiple input image signals obtained by the multiple wide-angle cameras; a lookup table for storing image mapping data related to relationships in which image pixels constituting each of the multiple input image signals obtained by the multiple wide-angle cameras are mapped to image pixels of a synthetic image signal; an image matching unit for receiving the multiple input image signals from the image signal reception unit, and constructing image pixels of the synthetic image signal mapped to the image pixels constituting each input image signal with reference to the lookup table; and an image signal output unit for generating an output image based on the synthetic image signal constructed by the image matching unit and outputting the output image.

In this case, the lookup table may be generated in such a way as to perform inverse operations on relationships in which individual image pixels constituting a sample output image are mapped to the image pixels of the multiple input image signals, the sample output image being generated by a distortion correction step performed on each of the multiple input image signals obtained by the wide-angle cameras, a homography step performed on each of input image signals, distortion of which has been corrected at the distortion correction step, a rearrangement step performed on each of homographic input image signals generated at the homography step, and a single image formation step performed on rearranged image signals obtained at the rearrangement step.

Further, the lookup table may be generated by determining from which of the wide-angle cameras each of the image pixels constituting the sample output image was obtained, and thereafter sequentially performing inverse operations of the single image formation step, the rearrangement step, the homography step, and the distortion correction step.

Furthermore, the lookup table may be configured such that one or more image pixels of the synthetic image signal are mapped to a single image pixel of each of the multiple input image signals obtained by the multiple wide-angle cameras.

Furthermore, the image matching unit may be configured to obtain, based on coordinates of individual image pixels constituting each of the multiple input image signals received from the image signal reception unit, coordinates of image pixels of the synthetic image signal mapped to the coordinates of the individual image pixels from the lookup table, and to record pixel values of the image pixels constituting the input image signal at the obtained coordinates, thus constructing the image pixels of the synthetic image signal.

In accordance with another aspect of the present invention, there is provided an image processing method of matching images obtained from multiple wide-angle cameras using the image processing apparatus set forth in any one of claims 1 to 5, the method including calculating coordinates of pixels of the synthetic image signal mapped to all image pixels constituting each of the input image signals obtained by the multiple wide-angle cameras by referring to the lookup table; and recording pixel values of the image pixels constituting each of the input image signals on pixels of the synthetic image signal mapped to the calculated coordinates.

### Advantageous Effects

In accordance with the present invention, there can be provided an image processing apparatus and method, which can promptly and efficiently construct multiple images obtained from multiple wide-angle cameras into a single homographic image.

Further, in accordance with the present invention, there can be provided an image processing apparatus and method wherein an image processing apparatus for constructing a plurality of multi-channel input images into a single homographic image can be manufactured at low cost, and real-time processing can be guaranteed even with lower-grade specifications.

### BRIEF DESCRIPTION OF THE DRAWINGS

FIG. 1 is a diagram showing the basic procedures of a conventional image synthesis system and images obtained in the respective procedures;

FIG. 2 is a block diagram showing the configuration of an embodiment of an image processing apparatus for matching images obtained from multiple wide-angle cameras according to the present invention;

FIG. 3 is a diagram showing an example of a lookup table used in the present invention;

FIG. 4 is a diagram showing the procedure of generating a lookup table; and

FIG. 5 is a flowchart showing an embodiment of an image processing method performed by the image processing apparatus for matching images obtained from multiple wide-angle cameras according to the present invention.

### DETAILED DESCRIPTION

### Best Mode

Hereinafter, embodiments of the present invention will be described in detail with reference to the attached drawings.

First, prior to the description of embodiments of the present invention, the principles of conventional technology related to the present invention will be briefly described.

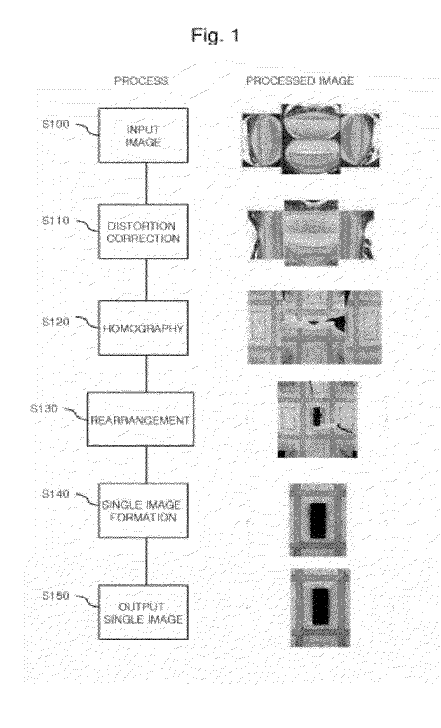

As described above, the conventional technology was proposed in which multiple, for example, four wide-angle cameras, each equipped with a fish-eye lens, are installed on the front and rear sides and the left and right sides of a vehicle and are configured to capture images in a direction horizontal to a ground surface, and in which the captured images are reconstructed into images that appear as if captured by looking down upon the vehicle from above (hereinafter, this conventional technology is simply referred to as an “image synthesis system” for the sake of description). The basic procedures of the conventional image synthesis system and images obtained in the respective procedures are illustrated in FIG. 1.

Referring to FIG. 1, the conventional image synthesis system includes six steps, which are an image input step S100, a distortion correction step S110, a homography step S120, a rearrangement step S130, a single image formation step S140, and a single image output step S150.

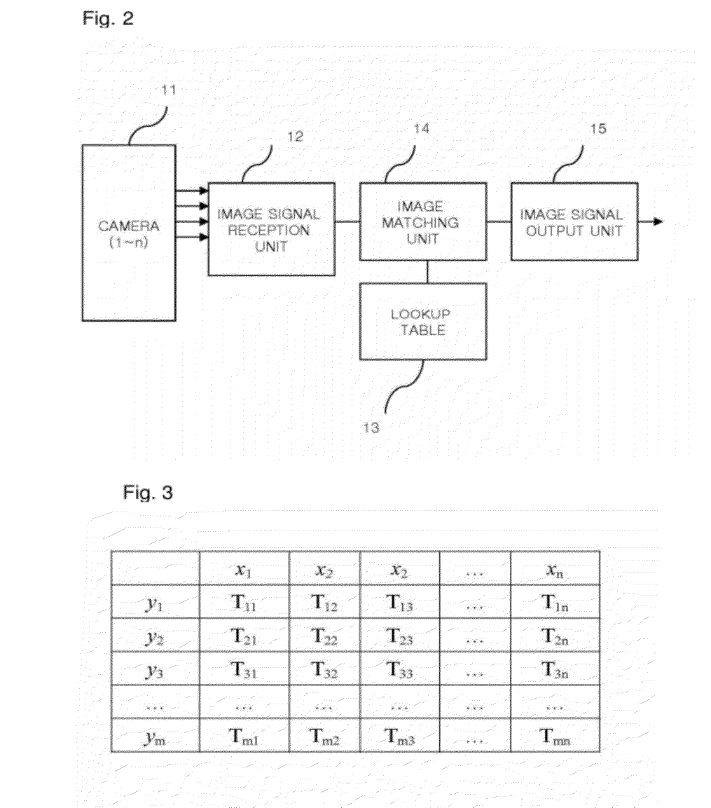

The image input step S100 is the procedure of receiving multiple image signals obtained by multiple wide-angle cameras. For example, when multiple cameras are mounted on the target object that is a vehicle, a total of four wide-angle cameras may be mounted on the front, rear, left, and right sides of the vehicle. In this case, captured images are displayed as shown in FIG. 1. Since the wide-angle cameras are each equipped with a fish-eye lens, wide viewing angles can be ensured. The reason for this is that, as will be described later, predetermined regions must overlap between the cameras due to image signals around the target object so as to reconstruct a single homographic image and viewing angles of the respective cameras must be wide so that images can be reconstructed using a smaller number of cameras in spite of the overlapping regions. Meanwhile, in the present invention, the term “camera” is a concept including other electronic devices such as an image sensor, as well as a fish-eye lens. That is, the camera refers to a device for converting optical signals into electrical signals rather than simply referring to an instrument for optically capturing images, and is defined as and used as a concept denoting, for example, a means for outputting signals in a format that can be input to and processed by the image processing apparatus, as shown in FIG. 2.

Next, the distortion correction step S110 is performed because when wide-angle cameras equipped with fish-eye lenses are used so as to use only a smaller number of cameras if possible, as described above, wide viewing angles can be ensured, but images become distorted radially in a direction toward the border of the obtained images. The distortion correction step S110 is the procedure of correcting such distorted images. The correction of the distortion caused by the fish-eye lenses may be mainly divided into two types of schemes, that is, “equi-solid angle projection” and “orthographic projection.” These are schemes for defining how to rearrange light incident on a fish-eye lens when the fish-eye lens is manufactured. A fish-eye lens manufacturing company manufactures fish-eye lenses by selecting one of the two schemes upon manufacturing fish-eye lenses. Therefore, when the inverse operation of a distortion operation is obtained according to the distortion scheme applied to the fish-eye lens, and images captured by the fish-eye lens are inversely transformed, “distortion-corrected” images can be obtained. The images transformed at that time are called “distortion-corrected images.” The distortion-corrected images may be displayed as shown in FIG. 1.

An operation expression required to perform distortion correction may be implemented using, for example, the following equation:

$${X}_{distortion \text{-} corrected image} = f tan ( 2 {sin}^{- 1} ( \frac{{R}_{f}}{2 f} ) ) \frac{{X}_{input image}}{{R}_{f}} \\ {Y}_{distortion \text{-} corrected image} = f tan ( 2 {sin}^{- 1} ( \frac{{R}_{f}}{2 f} ) ) \frac{{Y}_{input image}}{{R}_{f}} \qquad [ Equation 1 ]$$

where f denotes the focal distance of each camera, Rf denotes a distance from the optical center of the camera to (x, y) coordinates of a relevant input image, that is, (X_{input image}, Y_{input image}), X_{input image} and Y_{input image} denote (x, y) coordinate values of the input image, and X_{distortion-corrected image} and Y_{distortion-corrected image} denote (x,y) coordinate values of the distortion-corrected image.

Next, once distortion-corrected images have been obtained, the homography step is performed at step S120. The homography step S120 is the procedure of transforming the distortion-corrected images into images that appear as if captured by looking down upon a target object, that is, the object equipped with the cameras, from above the target object in a direction towards the ground surface, that is, in a perpendicular direction. As described above, since the distortion-corrected images obtained at the distortion correction step S110 correspond to images captured by respective cameras from different viewpoints, the procedure of transforming these images into images viewed from a single viewpoint, that is, a viewpoint of looking down in a perpendicular direction, is the homography step S120. The images obtained by performing the homography step S120 are called homographic images, and the images obtained after the performance of the homography step S120 may be displayed as shown in FIG. 1.

At the homography step, the following equation, for example, may be used:

$$[ \begin{matrix}{x}_{homographic image} \\ {y}_{homographic image} \\ 1\end{matrix} ] = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ] [ \begin{matrix}{x}_{distortion \text{-} correction image} \\ {y}_{distortion \text{-} corrected image} \\ 1\end{matrix} ] \qquad [ Equation 2 ]$$

where X_{distortion-corrected image} and Y_{distortion-corrected image} denote (x, y) coordinate values of each distortion-corrected image obtained in Equation 1, X_{homographic image} and Y_{homoographic image} denote (x,y) coordinate values of the homographic image obtained from the transform of Equation 2, and h₁₁, h₁₂, . . . , h₃₃ denote coefficients of a homography transform (this is referred to as a perspective transform).

Next, if the homographic images have been obtained, the rearrangement step (an affine transform) is performed at step S130. The rearrangement step S130, which is the step of rearranging the homographic images generated at the homography step by applying only displacement and rotation to the homographic images, is the step of reconstructing the images captured to enclose the target object as surrounding images except for the target object. Such a rearrangement step S130 may be performed using only the displacement and the rotation of pixels. For this operation, a method such as an affine transform may be used. Images generated by the rearrangement are called rearranged images, and may be displayed as shown in FIG. 1.

The rearrangement step may be performed using the following Equation:

$$[ \begin{matrix}{x}_{rearranged image} \\ {y}_{rearranged image} \\ 1\end{matrix} ] = [ \begin{matrix}{r}_{11} & {r}_{12} & {t}_{x} \\ {r}_{21} & {r}_{22} & {t}_{y} \\ 0 & 0 & 1\end{matrix} ] [ \begin{matrix}{x}_{homographic image} \\ {y}_{homographic image} \\ 1\end{matrix} ] \qquad [ Equation 3 ]$$

where X_{homographic image} and Y_{homographic image} denote (x, y) coordinate values of each homographic image obtained using Equation 2, x_{rearranged image} and y_{rearranged image} denote (x, y) coordinate values of each rearranged image to be transformed using Equation 3, r₁₁, r₁₂, r₂₁, and r₂₂ denote rotational transform coefficients, and tₓ and t_{y} denote displacement coefficients (r and t are combined and then an affine transform is defined).

Next, the single image formation step S140 is performed. Since the rearranged images are obtained by merely rearranging the images, the images captured from the surroundings of the target object have a common area and are arranged such that the common area overlaps between the images. Therefore, from the rearranged images having the common area, the single image formation step of processing the overlapping regions and obtaining a single representative image for the common area is required. The single image formation step may be performed using various types of implementation schemes and may vary according to the implementation scheme, so that only the principle of implementation is described in brief. When the common area occurs, the single image formation step may be performed to divide the common area into units of pixels and analyze the pixels, thus enabling a single image area to be constructed only using pixels arranged at more accurate locations. There are various criteria for determining pixels arranged at more accurate locations. The simplest criterion may be, for example, distances between the optical center of an image to which pixels belongs and the pixels. On the basis of this criterion, if the common area is reconstructed using only pixels located closer to the optical center among the overlapping pixels of the common area, the rearranged images may be constructed into a single image without causing overlapping regions. The image obtained at the single image formation step is called a single image, and may be displayed as shown in FIG. 1.

In this way, once the process leading to the single image formation step S140 has been performed, a single homographic image is obtained. When the single homographic image is output at step S150, an image that appears as if captured by looking down upon the surroundings of the target object from above in a perpendicular direction can be displayed, as shown in FIG. 1.

Meanwhile, the above Equations 1, 2 and 3 have been used by the prior art, and are not directly related to the present invention, and so a detailed description thereof is omitted. The individual coefficients especially in Equations 2 and 3 may be determined differently depending on the schemes or algorithms that are used. The present invention is not related to methods of calculating these coefficients, and is characterized in that inverse operations of used equations are performed regardless of which type of equations are used, and thus a detailed description thereof is omitted.

FIG. 2 is a block diagram showing the configuration of an embodiment of an image processing apparatus for matching images obtained from multiple wide-angle cameras according to the present invention.

Referring to FIG. 2, an image processing apparatus 10 for matching multiple images obtained from multiple wide-angle cameras (hereinafter simply referred to as an “image processing apparatus”) according to the present embodiment includes multiple wide-angle cameras 11, an image signal reception unit 12, a lookup table 13, an image matching unit 14, and an image signal output unit 15.

The multiple wide-angle cameras 11 are arranged such that capturing regions between neighboring wide-angle cameras partially overlap each other, and are configured to include two or more multiple cameras, capture individual images, convert the images into electrical signals, and transmit the electrical signals to the image signal reception unit 12. As described above, it should be noted that each camera 11 has a concept that includes electric devices, such as an image sensor for converting optical signals into electrical signals, as well as simple optical instruments. For example, when a target object is a vehicle, the wide-angle cameras 11 may be arranged on the front, rear, left, and right sides of the vehicle, and the respective cameras 11 are arranged such that the capturing regions thereof overlap at least partially each other between neighboring cameras 11.

The image signal reception unit 12 is a means for individually receiving two or more multiple input image signals obtained by the multiple wide-angle cameras 11, and is configured to transmit the received multiple input image signals to the image signal matching unit 14. If necessary, the image signal reception unit 12 may perform an image preprocessing procedure using a filter or the like.

The lookup table 13 is a means for storing image mapping data related to a relationship in which individual image pixels constituting the multiple input image signals obtained by the multiple wide-angle cameras 11 are mapped to image pixels of a synthetic image signal, and may be constructed in the form of, for example, FIG. 3.

Referring to FIG. 3, the lookup table 13 may be regarded as a kind of mapping table defining relationships obtained by mapping the coordinates (x, y) of the image pixels, constituting the multiple input image signals obtained by the multiple wide-angle cameras 11, to the coordinates (t11, t12, . . . , tmn) of the image pixels of the synthetic image signal. In FIG. 3, each of the coordinates (t11, t12, . . . , tmn) of the image pixels of the synthetic image signal may include multiple coordinates. The reason for this is that, as described above, the images obtained by the wide-angle cameras 11 are distorted images having wider viewing angles, so that the pixels of the individual image signals may be mapped in 1:N correspondence rather than in 1:1 correspondence when the obtained images are mapped to homographic images. For example, the coordinate t11 may be mapped to three pairs of coordinates (11, 12), (13, 15), and (14, 16) at three points. This lookup table includes a number of lookup tables that are identical to the number of input image signals obtained by the wide-angle cameras 11, that is, the number of cameras 11, and includes the coordinate values of the synthetic image signal mapped to each of the input image signals.

The procedure of generating the lookup table 13 will be described below.

As described above with reference to FIG. 1, the conventional image synthesis system performs the process including the image input step S100, the distortion correction step S110, the homography step S120, the rearrangement step S130, the single image formation step S140, and the single input output step S150, thus enabling a single homographic image (a synthetic image signal) to be generated from individual input image signals obtained by the multiple cameras 11. In order to generate the lookup table 13, a sample output image generated by performing the individual steps S100 to S150 may be used. That is, of the steps S100 to S150, the distortion correction step S110, the homography step S120, and the rearrangement step S130 are configured to perform operations using equations suitable for the respective steps, as described above. When inverse operations of such operations are performed on the individual pixels of the sample output image, the coordinates of the pixels of each of the input image signals mapped to the pixels of the sample output image can be obtained.

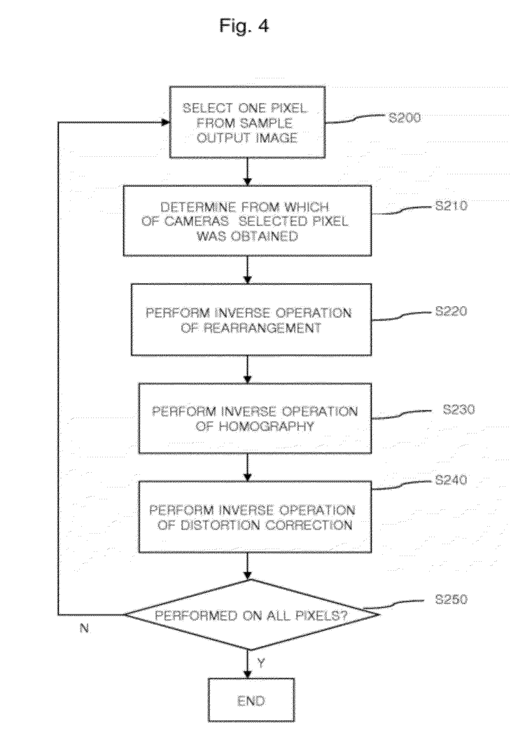

The procedure for generating the lookup table 13 is shown in FIG. 4.

Referring to FIG. 4, any one of pixels constituting the sample output image is selected at step S200. When a pixel is selected, it is determined from which of the multiple wide-angle cameras 11 the selected pixel was generated at step S210. This step may be regarded as the inverse step of the single image formation step S140. As described above, at the single image formation step, only one of pixels present in the overlapping region is determined based on a predetermined criterion, so that step S210 may be thought of as the step of determining from which of the cameras 11 the pixel selected at step S200 originated. It is convenient to use, as a method of performing this operation, a method of adding identifiers for enabling the respective cameras 11 to be identified to the respective input image signals generated by the multiple wide-angle cameras 11 and of subsequently checking these identifiers. That is, when the procedure described in FIG. 1 is performed, the identifiers enabling the cameras 11 that generated the respective input image signals to be identified are used together with the corresponding image signals, and thus the above method can be performed.

Next, the inverse operation of the equation that was used at the rearrangement step S130 is applied at step S220. As described above with reference to FIG. 1, when an equation such as Equation 3 was used, for example, at the rearrangement step S130, the inverse operation of the equation can be defined as follows:

$$[ \begin{matrix}{x}_{homographic image} \\ {y}_{homographic image} \\ 1\end{matrix} ] = {[ \begin{matrix}{r}_{11} & {r}_{12} & {t}_{x} \\ {r}_{21} & {r}_{22} & {t}_{y} \\ 0 & 0 & 1\end{matrix} ]}^{- 1} [ \begin{matrix}{x}_{single image} \\ {y}_{single image} \\ 1\end{matrix} ] \qquad [ Equation 4 ]$$

Next, the inverse operation of the equation that was used at the homography step S120 is applied at step S230. Similarly, when Equation 2 was used at the homography step S120, as described above with reference to FIG. 1, the inverse operation of Equation 2 can be defined as follows:

$$[ \begin{matrix}{x}_{distortion \text{-} corrected image} \\ {y}_{distortion \text{-} corrected image} \\ 1\end{matrix} ] = {[ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ]}^{- 1} [ \begin{matrix}{x}_{homographic image} \\ {y}_{homographic image} \\ 1\end{matrix} ] \qquad [ Equation 5 ]$$

Next, the inverse operation of the equation that was used at the distortion correction step S110 is applied at step S240. Similarly, when an equation such as Equation 1 was used at the distortion correction step S110, as described above with reference to FIG. 1, the inverse operation of Equation 1 can be defined as follows:

$${X}_{input image} = \frac{f 2 {X}_{distortion \text{-} corrected image}}{{R}_{p}} sin ( \frac{{tan}^{- 1} ( \frac{{R}_{p}}{f} )}{2} ) \\ {Y}_{input image} = \frac{f 2 {Y}_{distortion \text{-} corrected image}}{{R}_{p}} sin ( \frac{{tan}^{- 1} ( \frac{{R}_{p}}{f} )}{2} ) \qquad [ Equation 6 ]$$

where R denotes a distance from the optical center of the camera to (x,y) coordinates of the distortion-corrected image, that is, (X_{distortion-corrected image}, Y_{distortion-corrected image}).

If this procedure has been performed, the location of the pixel of the input image signal, obtained by the camera 11, to which the pixel (coordinates) of the synthetic image signal selected at step S200 is mapped, can be determined.

When this procedure is performed on all pixels of the synthetic image signal (the sample output image signal), the lookup table of FIG. 3 can be generated.

Meanwhile, Equations 4 to 6 which represent the inverse operations of Equations 1 to 3 are merely exemplary, and the equations of the present invention are not limited thereto. It should be noted that Equations 4 to 6 are defined as the inverse operations of used Equations 1 to 3 regardless of which type of Equations 1 to 3 are used.

Referring back to FIG. 2, the image matching unit 14 receives multiple input image signals from the image signal reception unit 12, and functions to construct image pixels of the synthetic image signal mapped to the image pixels constituting each input image signal with reference to the lookup table 13 generated as described above. That is, when the coordinate values of each of image pixels constituting each input image signal are used as the indices of the lookup table of FIG. 3, the coordinate values of the corresponding image pixel of the synthetic image signal can be obtained. Therefore, using the coordinate values, the pixel value (pixel data) of the image pixel of the input image signal mapped to the corresponding image pixel of the synthetic image signal is recorded to the corresponding image pixel, and thus the synthetic image signal is constructed. When this procedure is performed on all image pixels of each input image signal, pixel values of the corresponding pixels of the input image signals that are mapped to the coordinate values of all image pixels constituting the synthetic image signal can be recorded, thus enabling the synthetic image signal to be promptly generated.

As described above, the image signal output unit 15 functions to output an output image based on the synthetic image signal constructed by the image matching unit 14, and to display the output image on a display device provided outside of the apparatus, for example, a Liquid Crystal Display (LCD) monitor or the like.

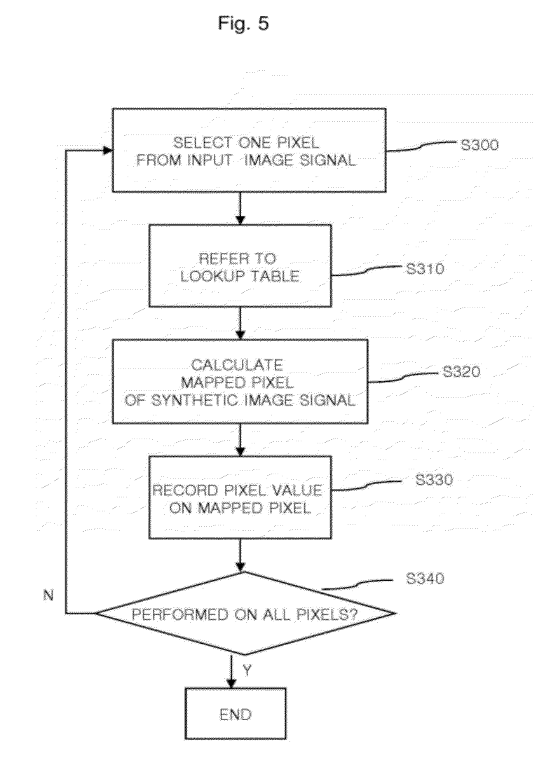

FIG. 5 is a flowchart showing an embodiment of an image processing method performed by the image processing apparatus for matching images obtained from multiple wide-angle cameras according to the present invention.

First, any one image pixel is selected from among the image pixels constituting an input image signal obtained by any one camera 11 of the multiple wide-angle cameras 11 at step S300.

After any one pixel has been selected, the lookup table 13 is referred to at step S310, and the coordinates of the pixel of a synthetic image signal mapped to the selected pixel are calculated at step S320. When the coordinates are calculated, a pixel value of the selected pixel is recorded on the mapped pixel of the synthetic image signal at step S330.

When the above procedure is performed on all pixels of each input image signal, all the pixels constituting the input image signal are mapped to the pixels constituting the synthetic image signal. When this procedure is performed on all of the remaining wide-angle cameras 11, all of the pixels constituting the input image signals of the multiple cameras 11 are individually mapped to all pixels constituting the synthetic image signal, and then pixels values (pixel data) of all the pixels of the synthetic image signal can be generated.

As described above, although the present invention has been described with reference to preferred embodiments, the present invention is not limited to the above embodiments, and those skilled in the art will implement various changes and modifications from the description of the present invention. For example, Equations 1 to 6 used in the above-described respective steps are exemplary, and equations other than these Equations may be used. It should be noted that the present invention is not especially limited by those equations at respective steps, and is characterized in that the lookup table is generated using the inverse operations of used equations, regardless of which type of equations have been used. In the case of the equations used in respective steps, any type of equations well known in the prior art may be used unchanged as long as it can be used to perform the operations at the respective steps as described above. Therefore, it should be understood that the present invention is interpreted with reference to the entire description of the accompanying claims and drawings, and all equal or equivalent modifications thereof belong to the scope of the present invention.

1. An image processing apparatus for matching images obtained from multiple wide-angle cameras, comprising:
two or more multiple wide-angle cameras arranged such that capturing regions between neighboring cameras partially overlap each other;
an image signal reception unit for receiving two or more multiple input image signals obtained by the multiple wide-angle cameras;
a lookup table for storing image mapping data related to relationships in which image pixels constituting each of the multiple input image signals obtained by the multiple wide-angle cameras are mapped to image pixels of a synthetic image signal;
an image matching unit for receiving the multiple input image signals from the image signal reception unit, and constructing image pixels of the synthetic image signal mapped to the image pixels constituting each input image signal with reference to the lookup table; and
an image signal output unit for generating an output image based on the synthetic image signal constructed by the image matching unit and outputting the output image.

2. The image processing apparatus according to claim 1, wherein the lookup table is generated in such a way as to perform inverse operations on relationships in which individual image pixels constituting a sample output image are mapped to the image pixels of the multiple input image signals, the sample output image being generated by a distortion correction step performed on each of the multiple input image signals obtained by the wide-angle cameras, a homography step performed on each of input image signals, distortion of which has been corrected at the distortion correction step, a rearrangement step performed on each of homographic input image signals generated at the homography step, and a single image formation step performed on rearranged image signals obtained at the rearrangement step.

3. The image processing apparatus according to claim 2, wherein the lookup table is generated by determining from which of the wide-angle cameras each of the image pixels constituting the sample output image was obtained, and thereafter sequentially performing inverse operations of the single image formation step, the rearrangement step, the homography step, and the distortion correction step.

4. The image processing apparatus according to claim 2, wherein the lookup table is configured such that one or more image pixels of the synthetic image signal are mapped to a single image pixel of each of the multiple input image signals obtained by the multiple wide-angle cameras.

5. The image processing apparatus according to claim 1, wherein the image matching unit is configured to obtain, based on coordinates of individual image pixels constituting each of the multiple input image signals received from the image signal reception unit, coordinates of image pixels of the synthetic image signal mapped to the coordinates of the individual image pixels from the lookup table, and to record pixel values of the image pixels constituting the input image signal at the obtained coordinates, thus constructing the image pixels of the synthetic image signal.

6. An image processing method of matching images obtained from multiple wide-angle cameras using the image processing apparatus set forth in claim 1, the method comprising:
calculating coordinates of pixels of the synthetic image signal mapped to all image pixels constituting each of the input image signals obtained by the multiple wide-angle cameras by referring to the lookup table; and
recording pixel values of the image pixels constituting each of the input image signals on pixels of the synthetic image signal mapped to the calculated coordinates.

7. An image processing method of matching images obtained from multiple wide-angle cameras using the image processing apparatus set forth in claim 2, the method comprising:
calculating coordinates of pixels of the synthetic image signal mapped to all image pixels constituting each of the input image signals obtained by the multiple wide-angle cameras by referring to the lookup table; and
recording pixel values of the image pixels constituting each of the input image signals on pixels of the synthetic image signal mapped to the calculated coordinates.

8. An image processing method of matching images obtained from multiple wide-angle cameras using the image processing apparatus set forth in claim 3, the method comprising:
calculating coordinates of pixels of the synthetic image signal mapped to all image pixels constituting each of the input image signals obtained by the multiple wide-angle cameras by referring to the lookup table; and
recording pixel values of the image pixels constituting each of the input image signals on pixels of the synthetic image signal mapped to the calculated coordinates.

9. An image processing method of matching images obtained from multiple wide-angle cameras using the image processing apparatus set forth in claim 4, the method comprising:
calculating coordinates of pixels of the synthetic image signal mapped to all image pixels constituting each of the input image signals obtained by the multiple wide-angle cameras by referring to the lookup table; and
recording pixel values of the image pixels constituting each of the input image signals on pixels of the synthetic image signal mapped to the calculated coordinates.

10. An image processing method of matching images obtained from multiple wide-angle cameras using the image processing apparatus set forth in claim 5, the method comprising:
calculating coordinates of pixels of the synthetic image signal mapped to all image pixels constituting each of the input image signals obtained by the multiple wide-angle cameras by referring to the lookup table; and
recording pixel values of the image pixels constituting each of the input image signals on pixels of the synthetic image signal mapped to the calculated coordinates.
